(19) United States
(12) Patent Application Publication
(10) Pub. No.: US 2008/0274242 A1
(43) Pub. Date: Nov. 6, 2008

(54) ANTIMICROBIAL COMPOSITIONS AND METHODS FOR TREATING PACKAGED FOOD PRODUCTS

(75) Inventors: Timothy A. Gutzmann, Eagan, MN (US); Scott L. Burnett, St. Paul, MN (US); Teresa C. Podtburg, Waconia, MN (US); Peter W. Bodnaruk, Lakeville, MN (US); Joy G. Herdt, Hastings, MN (US); Jocelyn H. Chopskie, Eagan, MN (US)

Correspondence Address: ECOLAB INC., MAIL STOP ESC-F7, 655 LONE OAK DRIVE, EAGAN, MN, 55121, US

(73) Assignee: ECOLAB INC., St. Paul, MN (US)

(21) Appl. No.: 11/779,596

(22) Filed: Jul. 18, 2007

Related U.S. Application Data
(60) Provisional application No. 60/807,956, filed on Jul. 21, 2006.

(51) Int. Cl. A23B 4/14

(52) U.S. Cl. 426/326

(57) ABSTRACT

A method of using an antimicrobial composition on a food product is described where the antimicrobial composition is applied to a food product, the food product is packaged and sealed, and then optionally activation energy is applied to the sealed food product.

### FIELD OF THE INVENTION

This disclosure provides a method of using an antimicrobial composition on a packaged food product where the antimicrobial composition is applied to a food product or within the food product package, the food product is packaged and sealed, and then optionally activation energy is applied to the sealed product to activate the antimicrobial composition.

### BACKGROUND

During the processing, preparation and packaging of food products, the food product may encounter microorganisms which make the food unsuitable for consumption. The microorganisms may come from the food itself, the food contact surfaces, or the surrounding environment. The microorganisms can include pathogenic microorganisms (e.g., Listeria monocytogenes, enterohemorrhagic Escherichia coli, and Salmonella) and spoilage organisms that affect the taste, color, or smell of the food product (e.g., Pseudomonas, Acinetobacter, Moraxella, Alcaligenes, Flavobacterium, and Erwinia). Microorganisms affect many food products including meat, poultry, fish and shellfish, cheese, fruits and vegetables, and pre-prepared foods. At certain levels, microorganisms on a food product cause a consumer's perception of a lower quality product, regulatory investigations and sanctions, foodbourne illness and death.

Food processors use several methods during processing to control or reduce microorganisms on food products. These methods include cleaning and sanitizing the plant environment, applying or incorporating antimicrobials to or in the food product, irradiating the food product, applying heat, and others. Applying or incorporating an antimicrobial composition to or in the food product is a preferred way of controlling microorganisms. But, it is difficult to formulate a composition that is effective at reducing microorganisms using ingredients that are acceptable for direct food contact according to government regulations. Further, it is difficult to formulate a composition that can be applied directly to a food product without adversely affecting the color, taste, or smell of the food product. Finally, once a food product has been treated with an antimicrobial composition or process to control the presence of microorganisms on the food product, the opportunity exists for the food product to become re-contaminated during further processing.

Food safety agencies have issued guidelines for processing food that may have exposure to surfaces contaminated with microorganisms including Listeria monocytogenes, Salmonella, and E. coli O157-H7. See e.g., Food Safety Inspection Service (FSIS) final rule for the control of Listeria monocytogenes in ready-to-eat (RTE) meat and poultry products, 9 CFR 430.

The FSIS guidelines on Listeria provide three alternatives for controlling the presence of Listeria on a RTE product. Under Alternative 1, an establishment applies a post-lethality treatment to the RTE product and an antimicrobial agent or process to control or suppress the growth of L. monocytogenes during the shelf life of the RTE product. Under Alternative 2, an establishment applies either a post-lethality treatment or an antimicrobial agent or process to suppress the growth of L. monocytogenes. Under Alternative 3, an establishment does not apply any post-lethality treatment or antimicrobial agent or process. Instead, it relies on its sanitation program to prevent the presence of L. monocytogenes. RTE products produced under Alternative 2 have greater control over Listeria contamination than RTE products produced under Alternative 3. Similarly, RTE products produced under Alternative 1 have greater control over Listeria contamination than those produced under Alternative 2. Facilities operating under Alternative 1 are subject to less agency intervention (e.g., inspections, recordkeeping, etc.) than an Alternative 2 or Alternative 3 facility.

Salmonella is prevalent on raw poultry, beef, and pork. And, Salmonella has a high incidence of causing foodbourne illness, and sometimes severe foodbourne illness. Establishments must employ processes validated to achieve specific levels of reduction of Salmonella organisms throughout their finished RTE meat and poultry product (6.5 log₁₀ throughout finished meat products and 7 log₁₀ throughout finished poultry products).

E. coli O157:H7 has been linked to foodbourne illness outbreaks. The FSIS has additional lethality performance standards for all fermented RTE products that include any amount of beef, except thermally-processed, commercially sterile products. Establishments must employ processes validated to achieve a 5.0 log₁₀ reduction of E. coli O157:H7 throughout fermented products containing beef.

It is against this background that the invention has been made.

### SUMMARY

Surprisingly, it has been discovered that microorganisms on food products can be controlled by applying an antimicrobial composition to the food product or within the food product package, packaging the food product, sealing the packaging and, optionally applying activation energy to the sealed food product to further activate the antimicrobial composition inside the packaging. This method has several advantages. For example, the initial application of the antimicrobial composition reduces the number of microorganisms on the surface of the food product on contact. Further, by allowing the antimicrobial composition to remain on the food product when the food product is packaged and sealed and optionally treated with an activation energy, the antimicrobial composition can reduce the number of microorganisms on the food product between the initial application and packaging if the food product becomes re-contaminated. The result is better control of pathogenic or spoilage microorganisms in the food product and enhanced consumer satisfaction.

These and other embodiments will be apparent to those of skill in the art and others in view of the following detailed description of some embodiments. This summary and the detailed description illustrate only some examples of various embodiments and are not intended to be limiting.

### BRIEF DESCRIPTION OF THE DRAWINGS

FIG. 1 illustrates a schematic of an immersion shrink tunnel.

FIG. 2 illustrates a schematic of a cascading shrink tunnel.

FIG. 3 illustrates a schematic of a cascading shrink tunnel with a bottom basin.

FIG. 4 illustrates a schematic of a drip flow shrink tunnel with a bottom jet.

FIG. 5 illustrates a schematic of a drip flow shrink tunnel with a bottom basin.

### DETAILED DESCRIPTION OF SOME EMBODIMENTS

The disclosure generally provides a method of controlling microorganisms on a food product by applying an antimicrobial composition to the food product or within the food product package, packaging the food product, sealing the packaging, and optionally applying activation energy to the sealed food product to further activate the antimicrobial composition inside the packaging. The disclosure also provides antimicrobial compositions to be used in conjunction with the method. It is understood that the various embodiments described may be combined to create a variety of unique embodiments and still remain within the scope of the disclosure.

In one of several aspects, the disclosure provides a method of controlling microorganisms on a food product by applying an antimicrobial composition to the food product or within the food product packaging, and packaging the food product where the antimicrobial composition is not rinsed off of the food product, and once the packaging is sealed, optionally applying activation energy to the sealed food product to activate the antimicrobial composition inside the packaging.

In certain embodiments, the method can be described in the following steps. First, the unpackaged food product enters the packaging area. Thereafter, an antimicrobial composition is applied in one of several ways to the food product either before, after, or substantially simultaneously with the packaging of the food product or in the final package before or after placing the food product in the package. The packaging is sealed. Following the packaging and sealing, the sealed food product is optionally exposed to a certain amount of activation energy for a period of time to activate the antimicrobial composition inside the packaging. Each of the steps will now be described in further detail.

### Application of the Antimicrobial Composition

The antimicrobial composition may be applied to the food product prior to, after, or substantially simultaneously with the packaging of the food product. In one particularly preferred embodiment, there are at least two antimicrobial agents, referred to as a first and second antimicrobial agent. The first and second antimicrobial agents may be part of one composition, or may be part of separate compositions mixed prior to application, or separate compositions applied substantially simultaneously or separate compositions applied sequentially. When applied sequentially, the first and second antimicrobial agent are preferably applied within about 48 hours, about 36 hours, about 24 hours, about an hour of each other, about 30 minutes of each other, about 10 minutes of each other, and about 1 minute of each other, about 30 seconds of each other, about 10 seconds of each other and about 5 seconds of each other. Preferably the amount of time in between the application of the first antimicrobial agent and the second antimicrobial agent is reduced as much as possible. If the amount of time in between application of the first and second antimicrobial agents is reduced, it will allow the first and second antimicrobial to intermingle with each other and allow for improved control of microorganisms. In some embodiments, it may be desirable for the first antimicrobial agent to be oxidative and the second antimicrobial agent to be non-oxidative.

The antimicrobial composition may be applied to the food product in several ways. In some embodiments, the antimicrobial composition may be applied directly to the food product in many ways including spraying, misting, rolling, fogging and foaming the antimicrobial composition directly onto the food product, and immersing the food product in the antimicrobial composition. The antimicrobial composition may be applied in an injection solution, or the antimicrobial composition may be applied as part of a marinade or tenderizer that is applied to the food product.

In some embodiments, the antimicrobial composition may be indirectly applied to the food product. The antimicrobial composition may be applied to the food product by applying the composition to processing equipment such as knives, cutting tools, etc. and using the processing equipment to transfer the composition to the food product. Also, the antimicrobial composition may be applied to the packaging prior to inserting the food product into the packaging or prior to applying the packaging to the food product. The antimicrobial composition then contacts the food product when the food product is packaged. The antimicrobial composition may be applied to the packaging after the food product has been inserted into the packaging or after applying the packaging to the food product (e.g., the antimicrobial composition may be squirted or otherwise introduced into the packaging after the food has been placed in the packaging but prior to sealing the packaging). The antimicrobial composition may be applied to the food product substantially simultaneously with the packaging of the food product. Additionally, it has already been discussed that food packaging or food casing (e.g., hot dog or sausage casing) may be coated, treated, or impregnated with the antimicrobial composition, and the antimicrobial composition is applied to the food product when the food product is placed inside the packaging or casing.

When using the food casing to apply the antimicrobial composition, the antimicrobial composition may be applied to the food product, specifically the hot dog or sausage, by coating, treating, or impregnating the casing with the antimicrobial composition prior to stuffing the casing with the meat product and prior to cooking. While not wanting to be bound to any scientific theory, it is believed that the moisture content of the food product will release the antimicrobial composition from the casing and allow it to coat the surface of the food product. Once the food product is cooked and the casing is removed, the antimicrobial composition is left on the surface of the food product to provide an antimicrobial barrier. The food product is then packaged and the antimicrobial composition is then optionally activated using activation energy.

When more than one antimicrobial agent is used, the first and second antimicrobial agents may be applied directly or indirectly using any of the above described application methods or combination of methods. For example, the first antimicrobial agent may be applied using one method and the second antimicrobial agent may be applied using the same method. Alternatively, the first antimicrobial agent may be applied using one method and the second antimicrobial agent may be applied using a different method.

Table A describes some non-limiting methods. It is understood that in the following table, the first and second antimicrobial agents may be selected from the list of antimicrobial agents described in the application. Further, it is understood that the application step may involve any of the previously described methods of application. Finally, it is understood that Table A is intended to be exemplary only and that other methods are envisioned including methods that include fewer and additional method steps, additional antimicrobial agents or compositions, pauses in between steps, and the like.

TABLE A
Exemplary Method Embodiments

| Step 1 | Step 2 | Step 3 | Step 4 | Step 5 |
|---|---|---|---|---|
| Apply a first antimicrobial | Package the food | Seal the | Optional | |
| agent to a food product | product | packaging | activation | |
| | | | energy step | |
| Apply a composition to a | Package the food | Seal the | Optional | |
| food product having a first | product | packaging | activation | |
| and second antimicrobial | | | energy step | |
| agent | | | | |
| Apply a first and second | Package the food | Seal the | Optional | |
| antimicrobial agent in | product | packaging | activation | |
| separate compositions | | | energy step | |
| substantially | | | | |
| simultaneously to a food | | | | |
| product | | | | |
| Apply a first antimicrobial | Apply a second | Package | Seal the | Optional |
| agent to a food product | antimicrobial agent | the food | packaging | activation |
| | to a food product | product | | energy step |
| Place food product in | Seal the packaging | Optional | | |
| packaging with a first | | activation | | |
| antimicrobial agent | | energy | | |
| | | step | | |
| Place food product in | Seal the packaging | Optional | | |
| packaging with a first and | | activation | | |
| second antimicrobial agent | | energy | | |
| | | step | | |
| Apply a first antimicrobial | Place food product | Seal the | Optional | |
| agent | (with first | packaging | activation | |
| | antimicrobial agent | | energy step | |
| | on the food product) | | | |
| | in packaging with a | | | |
| | second antimicrobial | | | |
| | agent inside the | | | |
| | packaging | | | |
| Apply percarboxylic acid | Apply carboxylic | Package | Seal the | Optional |
| composition to food | acid composition to | food | packaging | activation |
| product | food product | product | | energy step |
| Apply percarboxylic acid | Apply an acidified | Package | Seal the | Optional |
| composition to food | sodium chlorite | food | packaging | activation |
| product | composition to food | product | | energy step |
| | product | | | |
| Apply acidified sodium | Apply carboxylic | Package | Seal the | Optional |
| chlorite composition to | acid composition to | food | packaging | activation |
| food product | food product | product | | energy step |
| Apply acidified sodium | Apply percarboxylic | Package | Seal the | Optional |
| chlorite composition to | acid composition to | food | packaging | activation |
| food product | food product | product | | energy step |
| Apply a composition | Package food | Seal the | Optional | |
| having a percarboxylic | product | packaging | activation | |
| acid and carboxylic acid to | | | energy step | |
| food product | | | | |
| Apply a composition | Package food | Seal the | Optional | |
| having a percarboxylic | product | packaging | activation | |
| acid and acidified sodium | | | energy step | |
| chlorite to food product | | | | |
| Apply a composition | Package food | Seal the | Optional | |
| having an acidified | product | packaging | activation | |
| sodium chlorite and | | | energy step | |
| carboxylic acid to food | | | | |
| product | | | | |
| Apply percarboxylic acid | Place the food | Seal the | Optional | |
| composition to food | product in packaging | packaging | activation | |
| product | with a carboxylic | | energy step | |
| | acid composition | | | |
| Apply percarboxylic acid | Place the food | Seal the | Optional | |
| composition to food | product in packaging | packaging | activation | |
| product | with an acidified | | energy step | |
| | sodium chlorite | | | |
| | composition product | | | |
| Apply acidified sodium | Place the food | Seal the | Optional | |
| chlorite composition to | product in packaging | packaging | activation | |
| food product | with a carboxylic | | energy step | |
| | acid composition | | | |
| Apply acidified sodium | Place the food | Seal the | Optional | |
| chlorite composition to | product in packaging | packaging | activation | |
| food product | with a percarboxylic | | energy step | |
| | acid composition | | | |
| Place food product in | Seal the packaging | Optional | | |
| packaging with a | | activation | | |
| composition having a | | energy | | |
| percarboxylic acid and | | step | | |
| carboxylic | | | | |
| Place food product in | Seal the packaging | Optional | | |
| packaging with a | | activation | | |
| composition having a | | energy | | |
| percarboxylic acid and | | step | | |
| acidified sodium chlorite | | | | |
| Place food product in | Seal the packaging | Optional | | |
| packaging with a | | activation | | |
| composition having an | | energy | | |
| acidified sodium chlorite | | step | | |
| and carboxylic acid | | | | |

### Antimicrobial Composition

The method includes the application of an antimicrobial composition to the food product. The antimicrobial composition comprises at least one active antimicrobial ingredient. Additionally, the antimicrobial composition may also contain additional functional ingredients that aid in the function of the active antimicrobial ingredient, or impart a desired function or benefit.

There are a variety of active antimicrobial agents that may be used. Some non-limiting examples of antimicrobial agents that may be used include fatty acids, C₁-C₁₂ dicarboxylic acids, percarboxylic acids, halogen compositions or interhalogens thereof, a halogen donor composition, chlorine dioxide, acidified sodium chlorite, ozone, a quaternary ammonium compound, an acid-anionic organic sulfonate or sulfate, a protonated carboxylic acid, or mixtures thereof. Some non-limiting examples of fatty acids include C₆ to C₂₂ fatty acids. Fatty acids may be saturated in which all of the alkyl chain carbon atoms are connected by a single bond. Fatty acids can also be unsaturated where there are one or more double bonds between the carbon atoms. Non-limiting examples of saturated fatty acids include hexanoic (C₆), octanoic (C₈), nonanoic (C₉), decanoic (C₁₀), lauric (C₁₂), myristic (C₁₄), palmitic (C₁₆), stearic (C₁₈), arachidic (C₂₀), behenic (C₂₂) and the like. Non-limiting examples of unsaturated fatty acids include palmitoleic (C_{16:1}), oleic (C_{18:1}), linoleic (C_{18:2}), linolenic (C_{18:3}), arachidonic (C_{20:1}) and the like. Octanoic acid is a preferred fatty acid. Some non-limiting examples of percarboxylic acids include: C₁-C₁₀ percarboxylic acids, diperoxyglutaric acid, diperoxyadipic acid, diperoxysuccinic acid, diperoxysuberic acid, diperoxymalonic acid, peroxylactic acid, peroxyglycolic acid, peroxyoxalic acid, peroxypyruvic acid, and mixtures thereof. An exemplary percarboxylic acid antimicrobial product is that sold under the name INSPEXX™, commercially available from Ecolab Inc. (St. Paul, Minn.). Some non-limiting examples of halogen compounds and interhalogens thereof include: Cl₂, Br₂, I₂, ICl, IBr, ClBr, ICl₂⁻, IBr₂⁻, and mixtures thereof. Non-limiting examples of halogen donor compositions include: HOCl, HOI, HOBr, and the salts thereof; N-iodo, N-bromo, or N-chloro compounds; and N-bromosuccinamide, chloroisocyanuric acid, or 2-N-sodium-N-chloro-p-toluenesulfonamide. A non-limiting example of chlorine dioxide compositions includes chlorine dioxide generated from conventional chemical generators such as those sold by Prominent™ or preferably generated electrochemically using Halox™ generators. Some non-limiting examples of acidified sodium chlorite include the composition sold under the tradename SANOVA™, and commercially available from Ecolab Inc., (St. Paul, Minn.). A non-limiting example of ozone includes ozone generated electrochemically via high voltage discharge in oxygen. Non-limiting examples of quaternary ammonium compounds include: didecyldimethylammonium chloride, dioctyldimethylammonium chloride, octyldecyldimethylammonium chloride, alkyldimethylbenzylammonium chloride, and mixtures thereof. Non-limiting examples of acid-anionic organic sulfonates and sulfates include: acidic solutions of linear benzylsulfonic acid and sulfonated oleic acid. Non-limiting examples of protonated carboxylic acids include solutions with a pH less than 5 of one or more C₁-C₂₀ carboxylic acids. See U.S. Pat. Nos. 4,051,058, 4,051,059, 5,200,189, 5,200,198, 5,489,434, 5,718,910, 5,314,687, 5,437,868 for further discussion on peracid chemistry and the formation of an antimicrobial agent formulation. These patents are incorporated herein by reference in their entirety.

The active antimicrobial agent may include one active antimicrobial agent or a combination of more than one active antimicrobial agent. The active antimicrobial agent is preferably a GRAS (generally recognized as safe) or food grade composition. Some non-limiting examples of preferred active antimicrobial agents include fatty acids, acidified sodium chlorite, and peroxyacids such as peroxyacetic acid and peroxyoctanoic acid.

When applying the antimicrobial composition to the food product, the antimicrobial composition preferably contains from about 0.001 wt. % to about 10 wt. % of the active antimicrobial agent, from about 0.005 wt. % to about 5 wt. % of the active antimicrobial agent, and from about 0.01 wt. % to about 2 wt. % of the active antimicrobial agent. It is understood that different antimicrobial agents have different activities. A person skilled in the art will be able to select the antimicrobial composition and concentration to achieve the desired result.

As previously discussed, the antimicrobial composition may include additional functional ingredients in addition to the active antimicrobial agent. Examples of additional functional ingredients that may be included along with the active antimicrobial agent include oxidizers, carriers, chelating agents, hydrotropes, thickening and/or gelling agents, foaming agents, film-forming agents, surfactants, coupling agents, acidulants, buffering agents, pH adjusting agents, potentiators preservative, flavoring aids, fragrance, dye, and the like.

The antimicrobial composition may include one or more coupling agents for maintaining the raw materials of the composition in solution. The coupling agent is preferably a GRAS or food additive raw material. Some non-limiting examples of suitable coupling agents include propylene glycol esters, glycerol esters, polyoxyethylene glycerol esters, polyglycerol esters, sorbitan esters, polyoxyethylene sorbitan esters, polyoxyethylene-polyoxypropylene polymers, sulfonates, dioctyl sodium succinate, stearoyl lactylate, and complex esters such as acetylated, lactylated, citrated, succinhylated, or diacetyl tartarated glycerides. The coupling agent is preferably a sorbitan ester such as polyoxyethylene (20) sorbitan monooleate, commercially available as Polysorbate 80, polyoxyethylene (20) sorbitan monostearate, commercially available as Polysorbate 60, and polyoxyethylene (20) sorbitan monolaurate, commercially available as Polysorbate 20.

The antimicrobial composition optionally includes one or more buffers. The buffer is preferably the conjugate base of the acidulant used in the composition. Further, the buffer is preferably considered to be a GRAS or food additive raw material. The buffer can be added directly to the composition in the form of the salt of the acidulant or formed by adding a neutralizing base to the acidulant. For example, if the buffer is created in the composition then a neutralizing base should be added to the acidulant to form the corresponding buffering salt. The neutralizing base is preferably considered GRAS or food additive. Some non-limiting examples of suitable neutralizing bases include sodium hydroxide, potassium hydroxide, silicates, trisodiumphosphates and the like.

The buffer salts are preferably GRAS or food additive. Some non-limiting examples of suitable buffers include citric acid combined with sodium or potassium citrate, or phosphoric acid combined with monosodium phosphate, however, a person skilled in the art will be able to select the corresponding salt of the desired acidulant.

The buffer is preferably citric acid combined with sodium or potassium citrate.

The exact amount of the buffer in the composition will depend on the strength and amount of the acidulant and a person of ordinary skill in the art will be able to determine the exact weight percent of the buffer at equilibrium. However, when the composition is formulated as a concentrate composition, the buffer may be present in a concentration ranging generally from about 1 wt. % to about 50 wt. %, from about 1.5 wt. % to about 25 wt. %, and from about 2 wt. % to about 15 wt. %. When the composition is formulated as a ready-to-use composition, the buffer may be present in a concentration ranging generally from about 0.1 wt. % to about 10.0 wt. %, from about 0.2 wt. % to about 5.0 wt. %, and from about 0.4 wt. % to about 3.0 wt. %. The buffer is preferably included in the composition in an amount effective to maintain the pH of the ready-to-use composition from about 1.0 to about 5.6, from about 1.5 to about 4.5, and from about 2.0 to about 4.0.

The composition may include a preservative. Non-limiting examples of preservatives include sorbic acid, benzoic acid, ascorbic acid, and erythorbic acid. The preservatives can be included as the acid form, as salts or as a combination of acid and salts. Salts forms would include counter ions such as sodium, potassium, calcium and magnesium. Any additional functional ingredient is preferably a GRAS or food grade ingredient since the antimicrobial composition is preferably applied to the food product. Exemplary antimicrobial compositions are described in greater detail in the co-pending patent application entitled, ANTIMICROBIAL COMPOSITIONS FOR USE ON FOOD PRODUCTS, filed on Jul. 21, 2006 with attorney docket number 2254USU1 and Ser. No. 11/459,069, the entire disclosure of which is incorporated by reference herein. A person of ordinary skill in the art will be able to formulate compositions depending on the desired active antimicrobial agent, and the desired physical properties so that the various ingredients do not adversely affect each other.

In certain embodiments, it may be desirable for the pH of the composition to be substantially equivalent to the isoelectric point of the fresh meat protein. The isoelectric point of meat occurs at a pH of about 5.4 to 5.6. At the isoelectric point of proteins, the number of positive and negative charges are the same and the net charge is zero. As the pH of the meat and its immediate environment reach the isoelectric point of meat proteins, the protein spaces reduce, resulting in a reduced water holding capacity (WHC) of the meat. It is theorized that antimicrobial compositions at a pH within the range of 5.4 to 5.6 take advantage of the reduced WHC because the meat tissue holds less water and the dilution effect of the active antimicrobial species within the composition is reduced, thereby providing for improved bactericidal efficacy. It is also theorized that maintaining a pH level of the meat and the antimicrobial composition applied at or near the meat protein isoelectric point eliminates the potential for microorganisms to infiltrate into the myofibrillar tissues. Meat tissue reacts to acidic compositions, for example, by increasing its protein space, thereby allowing access into subsurface tissues by microorganisms which evade the disinfection activity by the applied antimicrobial. In addition, antimicrobial compositions at a pH within the range of 5.4 to 5.6 exhibit substantially reduced organoleptic impact compared to those at pH levels higher or lower than that range. For example, acidic antimicrobial compositions tend to convert myoglobin into metmyoglobin irreversibly. The result is a meat product with a color unacceptable to the consumer. Compositions at the meat isoelectric point do not result in the formation of metmyoglobin and the result is a more favorably colored meat product.

The antimicrobial composition may have a range of physical forms. For example, the antimicrobial composition may be a solid, liquid, structured or thickened liquid or gel, foam, pellet, prill, or a powder. Further, the antimicrobial composition may be a part of a dissolvable film such as polyvinylalcohol (PVA) or cellulose film, or the antimicrobial composition may be blown or extruded with a film, impregnated in a film, or coated on a film. Further, the antimicrobial composition may be formulated as a concentrate composition or a ready-to-use composition. A concentrate composition is often less expensive to ship than a ready-to-use composition. The concentrate refers to the composition that is diluted to form the ready-use-composition. The ready-to-use composition refers to the composition that is applied to the food product.

In certain embodiments, it may be desirable for the active antimicrobial agent to have a lasting effect once the food product is packaged and continue to provide a suppression of growth. For example, it may be desirable under Alternative 1 for the antimicrobial composition to continue to provide an antimicrobial effect over the entire shelf life of the food product and prevent the growth of microorganisms. In other embodiments, it may be desirable for the active antimicrobial agent to cease having an antimicrobial effect shortly after packaging or the activation energy is applied.

### Packaging

The food products may be packaged in a variety of ways including vacuum packaging, shrink wrapping, and modified atmosphere packaging. Further, the food products may be packaged in a variety of packaging materials including bags, pouches, films such as shrink films and non-shrink films, trays, bowls, clam shell packaging, web packaging, and hot dog/frankfurter packaging. The methods are especially useful in conjunction with the shrink wrap packaging that is used in a shrink wrap process.

The packaging of the food product may occur before, after, or substantially simultaneously with the application of the antimicrobial composition. In the cases where the antimicrobial composition is applied first, and the packaging takes place in a separate step, the packaging step preferably takes place no more than 30 minutes after the application of the antimicrobial composition, no more than 10 minutes after the application of the antimicrobial composition, no more than 60 seconds after the application of the antimicrobial composition, and no more than 5 seconds after the application of the antimicrobial composition. Reducing the amount of time in between the application of the antimicrobial composition to the food product, and when the food product is placed inside the packaging, reduces the likelihood that the food product will be re-contaminated in between the two steps.

### Activation Energies

The method optionally includes the application of activation energy to a product to activate the antimicrobial composition. When using activation energy, enough energy must be applied to the antimicrobial composition for a sufficient period of time in order to activate it. The exact amount of energy and length of time may vary depending on the antimicrobial composition, the food product, and the method of energy application. A person skilled in the art will be able to select the desired activation energy, and duration depending on the antimicrobial composition and food product.

Non-limiting examples of suitable activation energies that may be used with all of the methods described herein include heat, pressure, ultraviolet light, infrared light, ultrasonic, radio frequency, microwave radiation, gamma radiation, and the like. Preferred activation energies include heat, pressure, and microwave radiation. It is understood that different activation energies will have different parameters (i.e. amount, duration). A person skilled in the art will be able to select the activation energy and parameters to achieve the desired result.

When heat is used as the activation energy, the heat may be applied in several ways including but not limited to hot water, steam, and hot air.

When using heat as the activation energy, the temperature of the heat is preferably from about 160° F. (71° C.) to about 210° F. (99° C.), from about 180° F. (82° C.) to about 200° F. (93° C.), and from about 190° F. (88° C.) to about 200° F. (93° C.). It is understood that the temperatures provided describe the temperature of the composition (e.g., the temperature of the water or air) being applied to the packaged food product, and not the temperature of the food product. For other activation energies described, the activation energy used should correspond to the energy applied using heat at the above temperatures.

Non-limiting examples of application time for the above described activation energies, that may be used in conjunction with all of the methods, include about less than 60 seconds, from about 1 to about 60 seconds, from about 2 to about 20 seconds, and from about 3 to about 10 seconds.

It is understood that the heat activation of the present method is different from thermal surface treatment of a food product (e.g., hot water or pasteurization). In a thermal surface treatment process, a thermal source, such as hot water or steam, is applied to a food product either directly to the surface of the food product, or indirectly, by applying heat to the packaging surface. Typical thermal surface treatments apply high temperature heat and/or long exposure times in an effort to reduce the presence of microorganisms (e.g., provide a “lethal” amount of heat to kill microorganisms). Further, thermal surface treatments require large equipment capital investments and take up a lot of space in a processing facility. Finally, thermal surface treatments have negative organoleptic effects on the food product including color and odor changes and cause increases in liquid purge volumes on meat products. The heat activation provides little, if any, reduction in the level of microorganisms (e.g., a “sub-lethal” amount of heat) because the purpose of the addition of heat is to activate the applied antimicrobial composition which in turn reduces the level of microorganisms, not to use the heat itself to reduce the level of microorganisms. Additionally, the heat used in the method does not impact organoleptic properties or purge volumes.

While not wanting to be bound by any scientific theory, it is believed that the method works in one of two ways. First, energy is known to increase the kinetics of reactions responsible for cell death. Accordingly, the application of energy to food products treated with an antimicrobial composition may increase the efficacy of the antimicrobial composition based on this principle. Second, it is known that the phospholipids in the bilayer of bacterial membranes undergo radical changes in physical state over narrow temperature ranges, sometimes referred to as phase transition temperatures or melting temperatures. Similar conformational or denaturative changes take place in the intracellular organelles. It is believed that the method takes advantage of these phenomenons by exposing microorganisms to energy in order to reach or pass the phase transition temperature and creating a liquid crystal conformation in the bilayer in which the bilayer becomes more permeable to the antimicrobial composition. Further, the targeted organelles within the microorganism also exhibit conformational changes that make them more susceptible to the antimicrobial composition.

### Shrink Tunnels

In certain embodiments, the method may be carried out in a shrink tunnel using heat as the activation energy, and shrink-wrap film as the packaging. In the shrink wrapping process, a food product is vacuum-packaged in a packaging film that is designed to shrink when heated and form a film around the food product. Once vacuum-packaged, the packaged food product travels through a shrink tunnel that applies heat to the packaging to shrink the packaging around the food product. The heat may be applied in several ways including immersion into a heated bath, or through cascading hot water.

When the method is used in conjunction with a shrink tunnel, it may use standard shrink tunnel equipment, or modified shrink tunnel equipment. Some non-limiting examples of shrink tunnels are described in FIGS. 1-5. It is understood that the method may be used in any shrink tunnel including variations of the shrink tunnels described in FIG. 1-5 and that the shrink tunnels described in FIGS. 1-5 are intended to be exemplary. When referring to the figures, like structures and elements shown throughout are indicated with like reference numerals.

FIG. 1 illustrates a schematic of an immersion shrink tunnel generally (10). The immersion shrink tunnel (10) is full of heated water. In the immersion shrink tunnel (10), the food product (14) enters the immersion shrink tunnel (10) full of heated water on a conveyor (16). As the food product (14) is immersed in the heated water, the heated water shrinks excess packaging film while activating an antimicrobial composition applied to the food product.

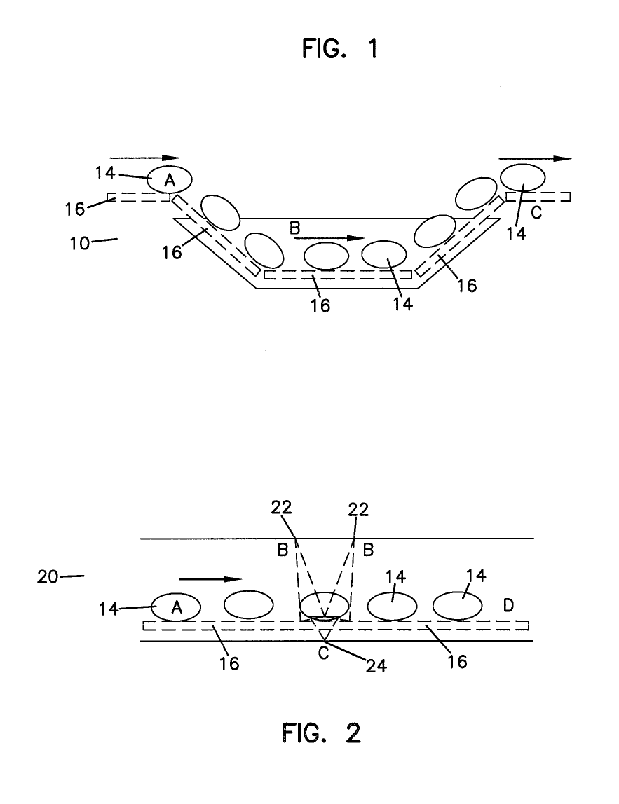

FIG. 2 illustrates a schematic of a cascading shrink tunnel generally (20). The cascading shrink tunnel (20) includes a conveyor (16). The cascading shrink tunnel (20) is fitted with multiple upper cascading water streams (22) that spray heated water on the top of the food product (14). From below the conveyor a jet of heated water (24) sprays the bottom of the food product (14). The food product (14) enters the shrink tunnel (20) on the conveyor (16) and the water streams (22) and jet (24) spray heated water on the food product (14) causing the excess packaging film to shrink while activating an antimicrobial composition applied to the food product.

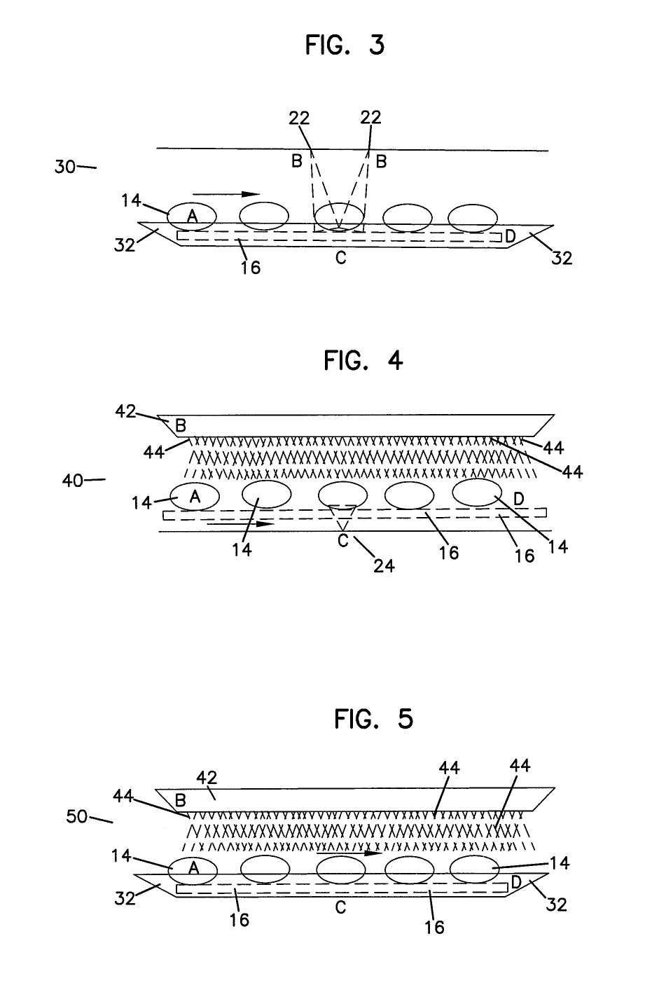

FIG. 3 illustrates a schematic of a cascading shrink tunnel with a bottom basin generally (30). The cascading shrink tunnel (30) includes a conveyor (16), multiple upper cascading water streams (22), and a bottom basin (32). The bottom basin (32) functions to collect heated water from the cascading water streams (22) and ensure that the bottom of the food product (14) is covered by heated water. The food product (14) enters the shrink tunnel (30) on the conveyor (16) and the water streams (22) spray heated water on the food product (14) as the food product (14) travels through the bottom basin (32) that is full of heated water from the cascading water streams (22). The heated water shrinks excess packaging film while activating an antimicrobial composition applied to the food product.

FIG. 4 illustrates a schematic of a drip flow shrink tunnel with a bottom jet generally (40). The drip flow shrink tunnel includes a conveyor (16) and an upper drip pan (42) that is full of heated water. The upper drip pan (42) includes many small holes (44) for allowing the heated water to flow out of the drip pan (42) and onto the food product (14). The advantage of this type of shrink tunnel is the extended exposure time of the food product (14) to heated water in comparison to the cascading shrink tunnel described in FIG. 2. From below, a jet of heated water (24) sprays the food product (14) with heated water. The food product (14) enters the shrink tunnel (40) on a conveyor (16) and is exposed to heated water from the drip pan (42) and from the jet of heated water (24). The heated water shrinks excess packaging film while activating an antimicrobial composition applied to the food product.

FIG. 5 illustrates a schematic of a drip flow shrink tunnel with a bottom basin generally (50). The shrink tunnel (50) includes a conveyor (16), an upper drip pan (42) that has many small holes (44) for allowing the heated water in the drip pan (42) to flow through, and a bottom basin (32) that is full of heated water. This shrink tunnel also has the advantage of an extended exposure time to heated water in comparison to the cascading shrink tunnel described in FIG. 2. The food product (14) enters the shrink tunnel (50) on a conveyor (16). The food product (14) is exposed to heated water from the upper basin (42) through the small holes (44), and from the lower basin (32) that is full of heated water. The heated water shrinks excess packaging film while activating an antimicrobial composition applied to the food product.

### Food Product

As used herein, the term “food product” or “food” refers to any food or beverage item that may be consumed by humans or animals. Some non-limiting examples of a “food product” or “food” include the following: meat products including ready-to-eat (“RTE”) meat and poultry products, processed meat and poultry products, cooked meat and poultry products, and raw meat and poultry products including beef, pork, and poultry products. Raw beef products include primal cuts such as chuck, rib, short loin, sirloin, round, brisket, plate, and flank, and associated sub primal cuts such as blade and arm cuts, back ribs, rib-eye steaks and roasts, rib roasts, top loin, tenderloin, bottom butt, top butt, sirloin steak, bottom round, top round, eye round, brisket, fore shank, short ribs and flank. Raw pork products include primal cuts such as shoulder, loin, leg/ham and side/belly, and associated sub primal cuts including blade shoulder, picnic shoulder, rib end, center cut, sirloin, butt half, shank half, side rib, and pork side. Fish products include cooked and raw fish, shrimp, and shellfish. Produce products include whole or cut fruits and vegetables and cooked or raw fruits and vegetables. And other food products include pizzas, ready made breads and bread doughs, cheese, eggs and egg-based products, and pre-made food items such as pre-made sandwiches. The methods are particularly useful for meat and poultry products. Specific examples of meat products including RTE deli or luncheon meats like turkey, ham, as well as roast beef, hot dogs and sausages. Additionally, the methods can be used on bacon and pre-made, pre-assembled, or pre-packaged meals such as TV dinners and microwaveable entrees or meals.

The following examples are given to illustrate some embodiments. These examples and experiments are to be understood as illustrative and not limiting. All parts are by weight, except where it is contrarily indicated.

### EXAMPLE 1

The following example demonstrates the improved efficacy of sequential treatment with an oxidative composition followed by a fatty acid composition in killing Listeria monocytogenes on a ready-to-eat turkey product in the method.

For this example sodium chlorite was diluted in water from about 500 ppm to about 1,200 ppm. The pH of the sodium chlorite was then adjusted using any GRAS acid such as citric acid or sodium bisulfate to about 2.4 to about 2.6. The second solution of octanoic acid was prepared containing from about 1,000 ppm to about 10,000 ppm of octanoic acid, from about 1.0 to about 4.0 wt. % ethylene oxide/propylene oxide copolymer (Pluronic F108), and about 2.0 to about 6.0 wt. % propylene glycol. The octanoic acid solution was adjusted to pH 2.0 with any GRAS acid such as phosphoric acid.

TABLE 1
An Acidified Sodium Chlorite (ASC) Composition Containing:

| Level (ppm) | Raw Material |
|---|---|
| 1200 | Sodium Chlorite |
| 6000 | Citric Acid |

Final Solution pH ~2.5

TABLE 2
An Octanoic Acid Composition Containing:

| Level (Wt. %) | Raw Material |
|---|---|
| 2.85 | Pluronic F108 |
| 5.00 | Propylene Glycol |
| 0.20 | Phosphoric Acid (75%) |
| 1.00 | Octanoic Acid |

Final Solution pH ~2.0

An equal-part mixture of five strains of L. monocytogenes including ATCC 19112, ATCC 19114, ATCC 19115, ATCC 7644, and NCTC 10890, suspended in Dey Engley Broth, was used as the inoculum. 0.1 milliliters of the inoculum was placed onto each RTE turkey breast, spread with a sterile bent glass rod, followed by storage at 5° C. for 10 minutes to allow for bacterial attachment. The acidified sodium chlorite solution was sprayed on the surface of the RTE product. Immediately after, the turkey breasts were placed into bags. The octanoic acid solution was then applied to the RTE product in the bag. In this example, the volume of each of the antimicrobial composition applied to each RTE turkey breasts was about 15 milliliters. The bags were immediately vacuum-packaged, and submerged in 200° F. water for 2 seconds to simulate passage through a shrink tunnel. The bags were then submerged in a 2° C. water bath for ≧1 minute. Two replicates were completed per treatment. The samples were stored at 5° C. for up to 14 days before analyzed for populations of L. monocytogenes. Fifty milliliters of University of Vermont broth were added to each bag. The RTE turkey breasts were tumbled to recover cells. The resulting suspension was plated in Modified Oxford Medium Agar and the plates were incubated at 35° C. for 72 hours prior to enumeration of L. monocytogenes.

TABLE 3
Efficacy of Acidified Sodium Chlorite and Octanoic Acid and
Heat on L. monocytogenes on RTE Turkey

| | 1 day of storage | | 14 days of storage | |
|---|---|---|---|---|
| | | Average | | Average |
| | Average Log₁₀ | Log₁₀ | Average Log₁₀ | Log₁₀ |
| Treatment | CFU/sample | Reduction | CFU/sample | Reduction |
| None | 4.09 | NA | 5.19 | NA |
| (Control) | | | | |
| ASC | 2.15 | 1.94 | 2.05 | 3.14 |
| ASC & | 1.94 | 2.15 | <1.70 | >3.49 |
| Octanoic Acid | | | | |

^{a}Limit of detection of the assay was 1.70 log₁₀ CFU/sample

Sequential treatment with acidified sodium chlorite and octanoic acid resulted in superior anti-listerial efficacy on RTE turkey breasts following 14 days of storage over treatment with ASC alone.

### EXAMPLE 2

The following example demonstrates the improved efficacy of sequential treatment with an oxidative composition followed by a fatty acid solution in killing Escherichia coli O157:H7 on raw beef brisket when used in the method.

For this example, aqueous solutions of 225 ppm peroxyacid and 0.9% octanoic acid were prepared containing the following compositions:

TABLE 4
A Peroxyacid Composition Containing:

| Level (ppm) | Raw Material |
|---|---|
| 775 | Acidic Acid |
| 225 | Mixed Percarboxylic Acids* |
| 140 | Octanoic Acid |
| 75 | Hydrogen Peroxide |
| 10 | HEDP |

*Mixture of peroxyacetic and peroxyoctanoic acids Final Solution pH ~1.5

TABLE 5
An Octanoic Acid Composition Containing:

| Level (%) | Raw Material |
|---|---|
| 2.50 | Citric Acid |
| 1.65 | Potassium Hydroxide |
| 2.50 | Propylene Glycol |
| 5.00 | Polysorbate 20 |
| 0.90 | Octanoic Acid |

Final Solution pH ~3.7

An equal-part mixture of five strains of E. coli O157:H7 including E0137, E0139, ATCC 35150, ATCC 43890, and LJF557 suspended in Dey Engley Broth, was used as the inoculum. One-hundred microliters of the inoculum was pipetted onto each brisket sample which were stored at 5° C. for 1 hour to allow for bacterial attachment. One set of inoculated brisket samples was placed in shrink-film bags and 6.5 mL of a 0.9% octanoic acid solution was dispensed over each sample. Bags were vacuum-sealed and heat shrunk to distribute the treatment solution over the surfaces of the samples. A second set of inoculated brisket samples was sprayed with a 225 ppm peroxyacid solution and packaged as described. A third set of inoculated brisket samples was sprayed with a 225 ppm peroxyacid solution, placed in shrink-film bags, treated with 6.5 mL of a 1% octanoic acid solution, and vacuum-sealed and heat shrunk as described. A fourth set of inoculated brisket samples was not treated and used as a control to calculate log reductions in the population of E. coli O157:H7 achieved by each treatment. After a 24-hour storage period at 5° C., the pathogen was recovered into Dey Engley Broth and enumerated on CT-SMAC agar.

TABLE 6
Efficacy of Sequential Treatment with 225 ppm Peroxyacid and 0.9%
Octanoic Acid in killing E. coli O157:H7 on Raw Beef Brisket

| | | Average | Average Log₁₀ |
|---|---|---|---|
| | | Log₁₀ CFU/ | Reduction Vs. |
| Treatment #1 | Treatment #2 | sample | Control |
| None (Control) | None (Control) | 6.83 | Not Applicable |
| Octanoic Acid | None | 6.02 | 0.81 |
| Solution | | | |
| Peroxyacid Acid | None | 5.87 | 0.96 |
| Solution | | | |
| Peroxyacid Acid | Octanoic Acid | 5.63 | 1.20 |
| Solution | Solution | | |

Treatment of raw beef brisket with peroxyacid followed by an in-package treatment using octanoic acid achieved a greater log reduction in E. coli O157:H7 populations than the log reduction achieved by each treatment applied individually.

### EXAMPLE 3

The following example demonstrates the improved efficacy of sequential treatment with an oxidative composition followed by a fatty acid solution in killing Escherichia coli O157:H7 on raw beef brisket when used in the method.

For this example, aqueous solutions of 1000 ppm acidified sodium chlorite and 0.9% octanoic acid were prepared with the following compositions:

TABLE 7
An Acidified Sodium Chlorite Composition Containing:

| Level (ppm) | Raw Material |
|---|---|
| 1000 | Sodium Chlorite |
| 6750 | Citric Acid |

Final Solution pH ~2.45

TABLE 8
An Octanoic Acid Composition Containing;

| Level (%) | Raw Material |
|---|---|
| 2.50 | Citric Acid |
| 2.50 | Propylene Glycol |
| 5.00 | Polysorbate 20 |
| 0.90 | Octanoic Acid |

Final Solution pH ~2.1

An equal-part mixture of five strains of E. coli O157:H7 including E0137, E0139, ATCC 35150, ATCC 43890, and LJF557 suspended in Dey Engley Broth, was used as the inoculum. One-hundred microliters of the inoculum was pipetted onto each brisket sample which were stored at 5° C. for 1.75 hours to allow for bacterial attachment. One set of inoculated brisket samples was placed in shrink-film bags and 6.5 mL of a 0.9% octanoic acid solution was dispensed over each sample. Bags were vacuum-sealed and heat shrunk 2 seconds at 200° F. to distribute the treatment solution over the surfaces of the samples. A second set of inoculated brisket samples was sprayed with 75 milliliters of a 1000 ppm acidified sodium chlorite solution and packaged as described. A third set of inoculated brisket samples was sprayed with a 1000 ppm acidified sodium chlorite solution, placed in shrink-film bags, treated with 6.5 mL of a 0.9% octanoic acid solution, and vacuum-sealed and heat shrunk as described. A fourth set of inoculated brisket samples was not treated and used as a control to calculate log reductions in the population of E. coli O157:H7 achieved by each treatment. After a 24-hour storage period at 5° C., the pathogen was recovered into Dey Engley Broth and enumerated on CT-SMAC agar.

TABLE 9
Efficacy of Sequential Treatment with 1000 ppm Peroxyacetic acid and
0.9% Octanoic Acid in killing E. coli O157:H7 on Raw Beef Brisket

| | | Average | Average Log₁₀ |
|---|---|---|---|
| | | Log₁₀ CFU/ | Reduction Vs. |
| Treatment #1 | Treatment #2 | sample | Control |
| None (Control) | None (Control) | 6.17 | Not Applicable |
| Octanoic Acid | None | 5.05 | 1.12 |
| Solution | | | |
| Acidified Sodium | None | 5.23 | 0.94 |
| Chlorite Solution | | | |
| Acidified Sodium | Octanoic Acid | 4.48 | 1.69 |
| Chlorite | Solution | | |

Treatment of raw beef brisket with acidified sodium chlorite followed by an in-package treatment using octanoic acid achieved a greater log reduction in E. coli O157:H7 populations than the log reduction achieved by each treatment applied individually.

### EXAMPLE 4

The following example demonstrates the improved efficacy of sequential treatment with an oxidative composition followed by a fatty acid solution in killing Escherichia coli O157:H7 on raw beef flanks when used in the method.

For this example, aqueous solutions of 1000 ppm acidified sodium chlorite and 0.9% octanoic acid were prepared with the following compositions:

TABLE 10
Acidified Sodium Chlorite Composition Containing:

| Level (ppm) | Raw Material |
|---|---|
| 1000 | Sodium Chlorite |
| 6750 | Citric Acid |

Final Solution pH ~2.48

TABLE 11
An Octanoic Acid Composition Containing;

| Level (%) | Raw Material |
|---|---|
| 2.50 | Citric Acid |
| 2.50 | Propylene Glycol |
| 5.00 | Polysorbate 20 |
| 0.90 | Octanoic Acid |

Final Solution pH ~2.06

An equal-part mixture of five strains of E. coli O157:H7 including E0137, E0139, ATCC 35150, ATCC 43890, and LJF557 suspended in Dey Engley Broth, was used as the inoculum. One-hundred microliters of the inoculum was pipetted onto each flank sample which were stored at 5° C. for 1 hour to allow for bacterial attachment. One set of inoculated flank samples was placed in shrink-film bags and 6.5 mL of a 0.9% octanoic acid solution was dispensed over each sample. Bags were vacuum-sealed and heat shrunk 2 seconds at 200° F. to distribute the treatment solution over the surfaces of the samples. A second set of inoculated flank samples was sprayed with 75 milliliters of a 1000 ppm acidified sodium chlorite solution and packaged as described. A third set of inoculated flank samples was sprayed with a 1000 ppm acidified sodium chlorite solution, placed in shrink-film bags, treated with 6.5 mL of a 0.9% octanoic acid solution, and vacuum-sealed and heat shrunk as described. A fourth set of inoculated flank samples was not treated and used as a control to calculate log reductions in the population of E. coli O157:H7 achieved by each treatment. After a 24-hour storage period at 5° C., the pathogen was recovered into Dey Engley Broth and enumerated on CT-SMAC agar.

TABLE 12
Efficacy of Sequential Treatment with 1000 ppm Peroxyacetic acid and
0.9% Octanoic Acid in killing E. coli O157:H7 on Raw Beef Flanks

| | | Average | Average Log₁₀ |
|---|---|---|---|
| | | Log₁₀ CFU/ | Reduction Vs. |
| Treatment #1 | Treatment #2 | sample | Control |
| None (Control) | None (Control) | 6.28 | Not Applicable |
| Octanoic Acid | None | 5.15 | 1.13 |
| Solution | | | |
| Acidified Sodium | None | 4.58 | 1.70 |
| Chlorite | | | |
| Acidified Sodium | Octanoic Acid | 4.48 | 1.80 |
| Chlorite | Solution | | |

Treatment of raw beef flank with acidified sodium chlorite followed by an in-package treatment using octanoic acid achieved a greater log reduction in E. coli O157:H7 populations than the log reduction achieved by each treatment applied individually.

### EXAMPLE 5

The following example demonstrates the improved efficacy of sequential treatment with an oxidative composition followed by a fatty acid solution in killing Escherichia coli O157:H7 and spoilage-causing psychrotrophic bacteria on raw beef flanks when used in the method.

For this example, aqueous solutions of 1.0% octanoic acid and 1020 ppm Acidified Sodium Chlorite (ASC) solution were prepared with the following compositions:

TABLE 13
An Octanoic Acid Composition Containing;

| Level (%) | Raw Material |
|---|---|
| 2.5 | Citric Acid |
| 3.0 | Polysorbate 20 |
| 1.0 | Octanoic Acid |

Final Solution pH ~2.2

TABLE 14
An Acidified Sodium Chlorite Composition Containing:

| Level (ppm) | Raw Material |
|---|---|
| 1020 | Sodium Chlorite |
| 6,707 | Citric Acid |

Final Solution pH ~2.45

An equal-part mixture of five strains of E. coli O157:H7 including E0137, E0139, ATCC 35150, ATCC 43890, and LJF557 suspended in phosphate buffered dilution water, was used as the inoculum. One-hundred microliters of the inoculum was pipetted onto each flank sample which were stored at 5° C. for 1 hour to allow for bacterial attachment. Flank samples were grouped into sets of three samples each. One set of inoculated flank samples was placed in shrink-film bags and 6.5 mL of a 1% octanoic acid solution was dispensed over each sample. Bags were vacuum-sealed and heat shrunk to distribute the treatment solution over the surfaces of the samples. A second set of inoculated flank samples was sprayed with a 1020 ppm acidified sodium chlorite solution and packaged as described above. A third set of inoculated flank samples was sprayed with a 1020 ppm acidified sodium chlorite solution, placed in shrink-film bags, treated with 6.5 mL of a 1% octanoic acid solution, and vacuum-sealed and heat shrunk as described. A fourth set of inoculated flank samples was not treated and used as a control to calculate log reductions in the population of E. coli O157:H7 achieved by each treatment. After a storage at 5° C. for 24 hours, the pathogen was recovered into Dey Engley Broth and enumerated on CT-SMAC agar. After storage at 5° C. for 20 days, psychrotrophic bacteria were enumerated from flank samples from each of the four groups by recovery in Dey Engley Broth and plating on tryptone glucose extract agar. Plates were incubated for up to 14 days following incubation at 5° C.

TABLE 15
Efficacy of Sequential Treatment with Acidified Sodium Chlorite and
1.0% Octanoic Acid in killing E. coli O157:H7 on Raw Beef Flanks

| | | | Average | Average Log₁₀ |
|---|---|---|---|---|
| | | | Log₁₀ | Reduction Vs. |
| Test | Treatment #1 | Treatment #2 | CFU/sample | Control |
| 1 | 1% Octanoic | None | 5.40 | 0.73 |
| | Acid Solution | | | |
| 2 | 1020 ppm | None | 4.75 | 1.38 |
| | Acidified | | | |
| | Sodium Chlorite | | | |
| | solution | | | |
| 3 | 1020 ppm | 1% Octanoic | 4.28 | 1.85 |
| | Acidified | Acid | | |
| | Sodium Chlorite | Solution | | |
| | solution | | | |
| 4 | None (Control) | None | 6.13 | Not Applicable |
| | | (Control) | | |

TABLE 16
Efficacy of Sequential Treatment with Acidified Sodium
Chlorite and 1.0% Octanoic Acid in killing psychrotrophic
bacteria on Raw Beef Flanks

| | | | Average | Average Log₁₀ |
|---|---|---|---|---|
| | | | Log₁₀ | Reduction Vs. |
| Test | Treatment #1 | Treatment #2 | CFU/sample | Control |
| 1 | 1% Octanoic | None | 6.78 | 1.76 |
| | Acid Solution | | | |
| 2 | 1020 ppm | None | 7.82 | 0.72 |
| | Acidified | | | |
| | Sodium Chlorite | | | |
| | solution | | | |
| 3 | 1020 ppm | 1% Octanoic | 4.80 | 3.74 |
| | Acidified | Acid | | |
| | Sodium Chlorite | Solution | | |
| | solution | | | |
| 4 | None (Control) | None | 8.54 | Not Applicable |
| | | (Control) | | |

Treatment of raw beef flanks with Acidified Sodium Chlorite followed by an in-package treatment using octanoic acid achieved a greater log reduction in E. coli O157:H7 and spoilage-causing psychrotrophic bacteria populations than the log reduction achieved by each treatment applied individually.

### EXAMPLE 6

The following example demonstrates the improved efficacy of sequential treatment with an oxidative composition followed by a fatty acid solution in killing Escherichia coli O157:H7 on raw beef flanks when used in the method.

For this example, aqueous solutions of 1.0% octanoic acid acidulated with either citric acid or lactic acid and 966 ppm Acidified Sodium Chlorite (ASC) solution were prepared with the following compositions:

TABLE 17
An Octanoic Acid Composition Acidulated
with Citric Acid Containing:

| Level (%) | Raw Material |
|---|---|
| 5.0 | Citric Acid |
| 3.5 | Polysorbate 20 |
| 1.0 | Octanoic Acid |

Final Solution pH ~2.2

TABLE 18
An Octanoic Acid Composition Acidulated
with Lactic Acid Containing:

| Level (%) | Raw Material |
|---|---|
| 8.8 | Lactic Acid |
| 10.0 | Propylene Glycol |
| 0.5 | Pluronic F108 |
| 1.0 | Octanoic Acid |

Final Solution pH ~2.0

TABLE 19
An Acidified Sodium Chlorite Composition Containing:

| Level (ppm) | Raw Material |
|---|---|
| 1000 | Sodium Chlorite |
| 6,750 | Citric Acid |

Final Solution pH ~2.43

An equal-part mixture of five strains of E. coli O157:H7 including E0137, E0139, ATCC 35150, ATCC 43890, and LJF557 suspended in Dey Engley Broth, was used as the inoculum. One-hundred microliters of the inoculum was pipetted onto each flank sample which were stored at 5° C. for 1 hour to allow for bacterial attachment. Flank samples were grouped into sets of three samples each. One set of inoculated flank samples was placed in shrink-film bags and 6.5 mL of a 1% octanoic acid solution acidulated with citric acid was dispensed over each sample. Bags were vacuum-sealed and heat shrunk to distribute the treatment solution over the surfaces of the samples. A second set of inoculated flank samples was sprayed with a 1000 ppm acidified sodium chlorite solution and packaged as described above. A third set of inoculated flank samples was sprayed with a 1000 ppm acidified sodium chlorite solution, placed in shrink-film bags, treated with 6.5 mL of a 1% octanoic acid solution acidulated with citric acid, and vacuum-sealed and heat shrunk as described. A fourth set of inoculated flank samples was placed in shrink-film bags and 6.5 mL of a 1% octanoic acid solution acidulated with lactic acid was dispensed over each sample. Bags were vacuum-sealed and heat shrunk to distribute the treatment solution over the surfaces of the samples. A fifth set of inoculated flank samples was sprayed with a 1000 ppm acidified sodium chlorite solution, placed in shrink-film bags, treated with 6.5 mL of a 1% octanoic acid solution acidulated with lactic acid, and vacuum-sealed and heat shrunk as described. A sixth set of inoculated flank samples was not treated and used as a control to calculate log reductions in the population of E. coli O157:H7 achieved by each treatment. After a 24-hour storage period at 5° C., the pathogen was recovered into Dey Engley Broth and enumerated on CT-SMAC agar.

TABLE 20
Efficacy of Sequential Treatment with Acidified Sodium Chlorite and
1.0% Octanoic Acid in killing E. coli O157:H7 on Raw Beef Flanks

| | | | Average | Average Log₁₀ |
|---|---|---|---|---|
| | | | Log₁₀ | Reduction Vs. |
| Test | Treatment #1 | Treatment #2 | CFU/sample | Control |
| 1 | 1% Octanoic | None | 4.42 | 1.34 |
| | Acid Solution | | | |
| | acidulated with | | | |
| | citric acid | | | |
| 2 | 1000 ppm | None | 4.30 | 1.46 |
| | Acidified | | | |
| | Sodium Chlorite | | | |
| | solution | | | |
| 3 | 1000 ppm | 1% Octanoic | 3.53 | 2.23 |
| | Acidified | Acid | | |
| | Sodium Chlorite | Solution | | |
| | solution | acidulated | | |
| | | with citric | | |
| | | acid | | |
| 4 | 1% Octanoic | None | 3.40 | 2.30 |
| | Acid Solution | | | |
| | acidulated with | | | |
| | lactic acid | | | |
| 5 | 1000 ppm | 1% Octanoic | 2.86 | 2.90 |
| | Acidified | Acid | | |
| | Sodium Chlorite | Solution | | |
| | solution | acidulated | | |
| | | with lactic | | |
| | | acid | | |
| 6 | None (Control) | None | 5.76 | Not Applicable |
| | | (Control) | | |

Treatment of raw beef flanks with Acidified Sodium Chlorite followed by an in-package treatment using octanoic acid acidified with either citric acid or lactic acid achieved a greater log reduction in E. coli O157:H7 populations than the log reduction achieved by each treatment applied individually.

### EXAMPLE 7

The following example demonstrates the improved efficacy of sequential treatment with an oxidative composition followed by a fatty acid solution in killing Escherichia coli O157:H7 on raw beef flanks when used in the method.

For this example, aqueous solutions of 1.0% octanoic acid acidulated with lactic acid and 1,023 ppm Acidified Sodium Chlorite (ASC) solution were prepared with the following compositions:

TABLE 21
An Octanoic Acid Composition Acidulated
with Lactic Acid Containing:

| Level (%) | Raw Material |
|---|---|
| 2.4 | Lactic Acid |
| 3.5 | Tween 20 |
| 1.0 | Octanoic Acid |

Final Solution pH ~2.3

TABLE 22
An Acidified Sodium Chlorite Composition Containing:

| Level (ppm) | Raw Material |
|---|---|
| 1,000 | Sodium Chlorite |
| 1,400 | Sodium Acid Sulfate |

Final Solution pH ~2.5

An equal-part mixture of five strains of E. coli O157:H7 including E0137, E0139, ATCC 35150, ATCC 43890, and LJF557 suspended in Dey Engley Broth, was used as the inoculum. One-hundred microliters of the inoculum was pipetted onto each flank sample which were stored at 5° C. for 1 hour to allow for bacterial attachment. Flank samples were grouped into sets of three samples each. One set of inoculated flank samples was placed in shrink-film bags and 6.5 mL of a 1% octanoic acid solution acidulated with lactic acid was dispensed over each sample. Bags were vacuum-sealed and heat shrunk to distribute the treatment solution over the surfaces of the samples. A second set of inoculated flank samples was sprayed with a 1000 ppm acidified sodium chlorite solution and packaged as described above. A third set of inoculated flank samples was sprayed with a 1000 ppm acidified sodium chlorite solution, placed in shrink-film bags, treated with 6.5 mL of a 1% octanoic acid solution acidulated with lactic acid, and vacuum-sealed and heat shrunk as described. A fourth set of inoculated flank samples was not treated and used as a control to calculate log reductions in the population of E. coli O157:H7 achieved by each treatment. After a 24-hour storage period at 5° C., the pathogen was recovered into Dey Engley Broth and enumerated on CT-SMAC agar.

TABLE 23
Efficacy of Sequential Treatment with Acidified Sodium Chlorite and
1.0% Octanoic Acid in killing E. coli O157:H7 on Raw Beef Flanks

| | | | Average | Average Log₁₀ |
|---|---|---|---|---|
| | | | Log₁₀ | Reduction Vs. |
| Test | Treatment #1 | Treatment #2 | CFU/sample | Control |
| 1 | 1% Octanoic | None | 4.59 | 1.09 |
| | Acid Solution | | | |
| | acidulated with | | | |
| | lactic acid | | | |
| 2 | 1000 ppm | None | 3.53 | 2.15 |
| | Acidified | | | |
| | Sodium Chlorite | | | |
| | solution | | | |
| 3 | 1000 ppm | 1% Octanoic | 3.18 | 2.50 |
| | Acidified | Acid | | |
| | Sodium Chlorite | Solution | | |
| | solution | acidulated | | |
| | | with lactic | | |
| | | acid | | |
| 4 | None (Control) | None | 5.68 | Not Applicable |
| | | (Control) | | |

Treatment of raw beef flanks with Acidified Sodium Chlorite followed by an in-package treatment using octanoic acid acidified with lactic acid achieved a greater log reduction in E. coli O157:H7 populations than the log reduction achieved by each treatment applied individually.

### EXAMPLE 8

The following example demonstrates the ongoing technical effect with the inclusion of preservative agents to the antimicrobial composition. An octanoic acid (OA) solution treatment with and without preservative agents was applied to fresh beef briskets and naturally occurring populations of psychrotrophic bacteria were measured after refrigerated storage.

One of three treatment solutions was applied to cut beef brisket samples. 1) a solution of 1% OA using Polysorbate 20 as a coupler, acidified to pH 5.5 using citric acid; 2) a solution of 1% OA using Polysorbate 20 as a coupler, 2,600 ppm benzoic acid, 750 ppm sorbic acid, acidified to pH 4.2 using citric acid; 3) water control. Samples of cut beef brisket (10 cm×20 cm×5.5 cm) were prepared and placed in shrink bags. 15 ml of one of the treatment solution was added to each bag. Bags were vacuum-packaged, submersed in 200° F. water for 2 seconds to simulate passage through a shrink tunnel and stored at 10° C. for up to 21 days. Three replicates per treatment were completed.

Samples were removed from storage after 3 or 21 days and analyzed for populations of psychrotrophic microorganisms. 50 ml of 2× Dey/Engley Neutralizing medium were added to each sample bag. Samples were tumbled for 50 rotations in a rotary tumbler and resulting suspension was plated on tryptone glucose extract agar. Plates were incubated at 10° C. for 7 days prior to enumeration of CFU per sample.

TABLE 24
Efficacy of 1.0% Octanoic Acid with and without Preservatives in
Controlling Populations of Psychrotrophic bacteria on Raw Beef Brisket.

| | | Average Log₁₀ | | Average Log₁₀ |
|---|---|---|---|---|
| | Average Log₁₀ | Reduction Vs. | Average Log₁₀ | Reduction Vs. |
| Treatment | CFU/sample | Control | CFU/sample | Control |
| Solution | At Day 3 | At Day 3 | At Day 21 | At Day 21 |
| 1% Octanoic | 5.82 | 1.12 | 9.68 | 0.77 |
| Acid Solution | | | | |
| acidulated with | | | | |
| citric acid to pH | | | | |
| 5.5 | | | | |
| 1% Octanoic | 5.86 | 1.08 | 7.80 | 2.65 |
| Acid Solution, | | | | |
| with 2,600 ppm | | | | |
| benzoic acid | | | | |
| and 750 ppm | | | | |
| sorbic acid | | | | |
| acidulated with | | | | |
| citric acid to pH | | | | |
| 4.2 | | | | |
| Water Control | 6.94 | n/a | 10.46 | n/a |

The use of sorbic acid and benzoic acid in combination with an octanoic acid solution provided control of psychrotrophic bacteria on raw beef Briskets.

### EXAMPLE 9

Beef tenderloin was treated with two compositions containing octanoic acid and inspected visually for their desirability factor based on color by a sensory panel of at least 12 people. The first composition was formulated at pH 3.7 and the second was formulated at pH 5.5. Compositions were added into the vacuum-package bag which contained the beef tenderloin samples. One subset of beef tenderloin samples was left untreated and served as a control. Following treatment, samples were vacuum packed and stored for three days at 2-8° C. Samples were then removed from vacuum-packages and cut into steaks. Steaks were held aerobically for up to 2 days at 2-8° C. At 2 hours and 2 days of storage, steaks were removed from storage at 2-8° C. and inspected for desirability based on color. A score of 1 indicates the panelist disliked very much the color of the steaks. A score of 5 indicates the panelist liked very much the color of the steaks. The threshold of desirability was held at a score of 2.5. Results show that the beef tenderloin treated with the composition at pH 5.5 remained above the desirability threshold throughout the 2 day storage time, whereas the desirability of the control steaks reduced substantially over the same period. Steaks treated with the composition at pH 3.7 where not acceptable at either time point analyzed.

TABLE 25
Quality of Beef Tenderloin treated with Octanoic Acid
formulated at pH 5.5 or pH 3.7. Hedonic scale;
1 = dislike very much; 5 = like very much.

Aerobic
Storage Time

| Treatment Solution | 2 hours | 2 days |
|---|---|---|
| 1% Octanoic Acid Solution acidulated | 1.4 | 1.8 |
| with citric acid to pH 3.7 | | |
| 1% Octanoic Acid Solution acidulated | 3.1 | 2.8 |
| with citric acid to pH 5.5 | | |
| Control | 4.5 | 2.2 |

### DEFINITIONS

For the following defined terms, these definitions shall be applied, unless a different definition is given in the claims or elsewhere in this specification.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

Weight percent, percent by weight, % by weight, wt %, and the like are synonyms that refer to the concentration of a substance as the weight of that substance divided by the weight of the composition and multiplied by 100.

The recitation of numerical ranges by endpoints includes all numbers subsumed within that range (e.g. 1 to 5 includes 1, 1.5, 2, 2.75, 3, 3.80, 4 and 5).

As used in this specification and the appended claims, the singular forms “a,” “an,” and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

The use of the terms “antimicrobial” in this application does not mean that any resulting products are approved for use as an antimicrobial agent.

What is claimed is:

1. A method of treating a food product comprising:
a) applying a first antimicrobial composition to the food product;
b) applying a second antimicrobial composition to a food product within 48 hours of the first antimicrobial composition, the second antimicrobial composition comprising octanoic acid, a coupling agent and a buffer;
c) packaging the food product; and
d) sealing the packaging.

2. The method of claim 1, wherein the second antimicrobial composition is applied within 36 hours of the first antimicrobial composition.

3. The method of claim 1, wherein the second antimicrobial composition is applied within 24 hours of the first antimicrobial composition.

4. The method of claim 1, wherein the second antimicrobial composition is applied within an hour of the first antimicrobial composition.

5. The method of claim 1, wherein the second antimicrobial composition is applied within 30 minutes of the first antimicrobial composition.

6. The method of claim 1, wherein the second antimicrobial composition is applied within 10 minutes of the first antimicrobial composition.

7. The method of claim 1, wherein the second antimicrobial composition is applied within one minute of the first antimicrobial composition.

8. The method of claim 1, wherein the first antimicrobial composition comprises an antimicrobial agent selected from the group consisting of peracid and acidified sodium chlorite.

9. The method of claim 1, wherein the first antimicrobial composition comprises an antimicrobial agent that is oxidative.

11. The method of claim 1, wherein the first antimicrobial composition comprises an antimicrobial agent that is non-oxidative.

12. The method of claim 1, wherein the first antimicrobial composition and second antimicrobial composition are applied substantially simultaneously.

13. The method of claim 1, wherein the second antimicrobial composition is applied when the food product is placed inside of the packaging.

14. The method of claim 1, wherein the second antimicrobial composition has a pH from about 5.4 to 5.6.

15. The method of claim 1, wherein the packaging is selected from the group consisting of bags, pouches and films.

16. The method of claim 1, wherein the packaging is a shrink film.

17. A method of treating a food product comprising:
a) applying a first antimicrobial composition comprising an antimicrobial agent selected from the group consisting of peracid and acidified sodium chlorite;
b) applying a second antimicrobial composition within an hour of the first antimicrobial agent, the second antimicrobial composition comprising octanoic acid, a coupling agent, and a buffer;
c) packaging the food product; and
d) sealing the packaging.
